(19) United States
(12) Patent Application Publication
(10) Pub. No.: US 2002/0143661 A1
(43) Pub. Date: Oct. 3, 2002

(54) System and method for prioritizing customer inquiries

(76) Inventors: William J. Tumulty, Richmond, VA (US); Terry Wayne Thornton, Glen Allen, VA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/820,982

(22) Filed: Mar. 30, 2001

(51) Int. Cl. G06F 17/60; H04M 3/00; H04M 5/00

(52) U.S. Cl. 705/27; 379/266.01

(57) ABSTRACT

A system and method is provided for prioritizing calls. The disclosed system and method involve receiving an inquiry from a customer. The customer is prompted to input an identification number. If the customer inputs the identification number then customer information associated with that identification number is retrieved, and a customer prioritization score is computed based on the customer information. If the customer fails to input the identification number or no identification number is requested, the customer is prompted to respond to queries and a customer prioritization score is computed based on the customer responses. Based on the computed customer prioritization score, the customer inquiry is prioritized.

### BACKGROUND OF THE INVENTION

I. Field of the Invention

The present invention relates to prioritization systems and methods. More particularly, the invention relates to systems and methods for prioritizing customer inquiries.

II. Background and Material Information

Marketing products and services to customers, including, for example, cellular service plans involves several steps. Among other things, a marketer must first target the right demographic with the right message about a product using the right medium. For example, television advertisements may be aired at specific times based on the belief that a specific segment of the population may be watching. Second, having generated an interest in the marketed product, the marketer must then be able to respond to customer inquires about that product.

Typically, a marketer may staff a customer contact center for handling customer inquiries related to a marketed product. Because of high staffing expenses associated with such centers, it is typically not economical to provide enough staff such that all incoming calls are answered immediately. Indeed, there may be spikes in the number of incoming calls. This dynamic is especially problematic with certain advertising channels. Real time media channels such as television create large spikes in call volume immediately after an advertisement promoting a product has just aired. Anticipating such spikes and staffing the contact center accordingly is difficult because of constraints on allocation and distribution of human capital. This situation typically results in a significant number of abandoned calls, i.e., calls which are abandoned by the callers because of long wait times to reach a customer representative.

When callers who are more likely to purchase the offered product abandon their calls, the marketer loses revenue. In sum, the marketer's goal is not necessarily to serve all callers, but is to serve those callers who are most likely and able to purchase the product or service at issue.

In view of the foregoing, there is presently a need for a system and method for prioritizing customer inquires to a customer contact center.

### SUMMARY OF THE INVENTION

Systems and methods consistent with the present invention maximize revenue at call centers by assigning higher priority, and thus reducing the wait time for those callers more likely to purchase an offered product or service.

Specifically, according to one aspect of the invention, a method for prioritizing a customer inquiry is provided. The method receives an inquiry from a customer. The method further prompts the customer to provide at least one of an identification number or customer information in response to a predetermined set of queries. The method further retrieves customer information about the customer based on the provided identification number. The method further computes a customer prioritization score based on the retrieved customer information. And the method prioritizes the customer inquiry based on the computed customer prioritization score.

According to another aspect of the invention, another method for prioritizing a customer inquiry is provided. The method receives an inquiry from a customer. The method prompts the customer to provide at least one of identification number or customer information in response to a predetermined set of queries. The method, when the customer provides customer information in response to the predetermined set of queries, computes a customer prioritization score based on the customer responses. And the method prioritizes the customer inquiry based on the computed customer prioritization score.

According to another aspect of the invention, a system for prioritizing a customer inquiry is provided. The system includes means for receiving an inquiry from a customer. The system further includes means for prompting the customer to provide at least one of an identification number or customer information in response to a predetermined set of queries. The system further includes, when the customer provides the identification number, means for retrieving customer information about the customer based on the provided identification number. The system further involves means for computing a customer prioritization score based on the retrieved customer information. And the system includes means for prioritizing the customer inquiry based on the computed customer prioritization score.

According to yet another aspect of the invention, a system for prioritizing a customer inquiry is provided. The system includes means for receiving an inquiry from a customer. The system further includes means for prompting the customer to provide at least one of an identification number or customer information in response to a predetermined set of queries. The system further includes, when the customer provides customer information in response to the predetermined set of queries, means for computing a customer prioritization score based on the customer responses. And the system includes means for prioritizing the customer inquiry based on the computed customer prioritization score.

Both the foregoing general description and the following detailed description are exemplary and are intended to provide further explanation of the invention as claimed.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which the features of the present invention may be implemented;

FIG. 2 depicts an exemplary system consistent with the present invention; and

FIG. 3 is an exemplary flowchart of a process for prioritizing an inquiry from a customer consistent with the present invention.

### DETAILED DESCRIPTION

Systems and methods consistent with the present invention solve the problems associated with lost revenue at customer contact centers when qualified and interested customers abandon calls. In particular, the system prioritizes customer inquiries to maximize revenue.

Upon receiving a customer inquiry, the system prompts the customer to respond to one or more prioritization queries. From the received responses, the system calculates a prioritization score describing further, the customer's likelihood to make a purchase and/or an expected value of any purchases. The system then prioritizes the customer's inquiry based on the calculated score. Alternatively, a customer may be prompted to enter an identification number. From this number, the system can access customer information used to determine a prioritization score for prioritizing the inquiry. In this way, the system maximizes revenue to the underlying business by assigning a higher priority to those customers likely to generate revenue.

The features of the present invention may be implemented in various system or network environments to provide automated computational tools to facilitate prioritization of a customer inquiry. Such environments and applications may be specially constructed for performing the various processes and operations of the invention or they may include a general-purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well known and available to those having skill in the computer software arts. Examples of program instructions include both machine code, such as produced by compiler, and files containing a high level code that can be executed by the computer using an interpreter.

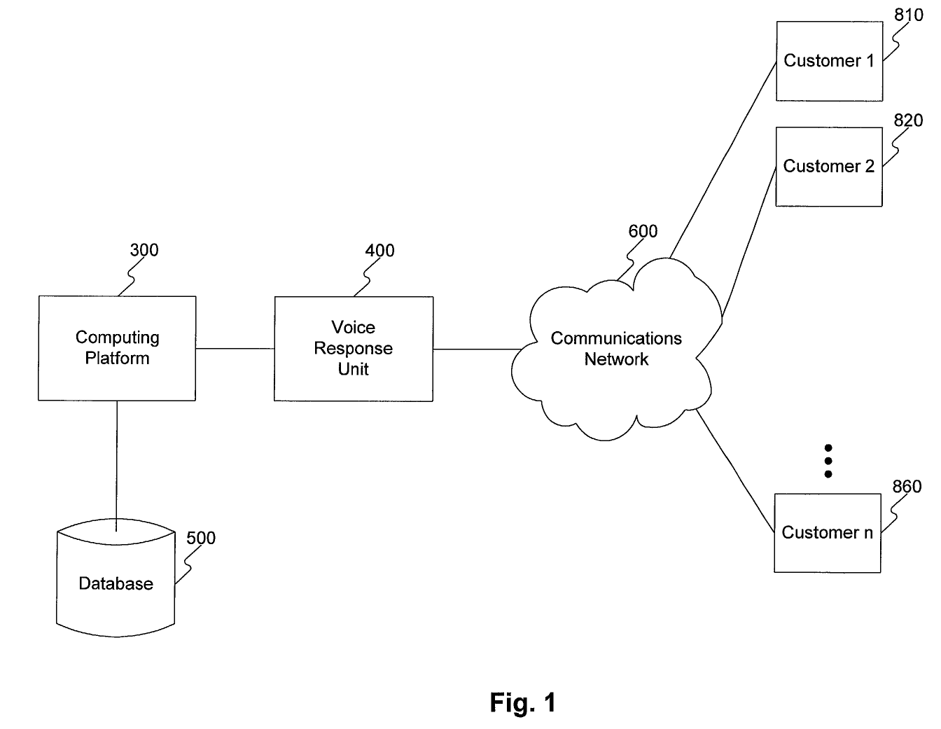

By way of a non-limiting example, FIG. 1 illustrates a system environment 50 in which the features and principles of the present invention may be implemented. As illustrated in the block diagram of FIG. 1, system environment 50 includes a computing platform 300, a voice response unit 400, a database 500, which are connected via communications network 600 to customers, such as customer 1 810, customer 2 820, . . . customer n 860. Customers may use system environment 50 to call a particular telephone number or a similar service.

Computing platform 300 is adapted to provide the necessary functionality and computing capabilities to prioritize a customer inquiry received at a contact center. Computing platform 300 is connected to voice response unit 400 to receive information entered by the customer upon being prompted by the voice response unit. Computing platform 300 is also operatively connected to database 500 for retrieving information from database 500.

In the embodiment of FIG. 1, computing platform 300 preferably comprises a PC or mainframe computer for performing various functions and operations of the invention. Computing platform 300 may be implemented, for example, by a general purpose computer selectively activated or reconfigured by a computer program stored in the computer, or may be a specially constructed computing platform for carrying-out the features and operations of the present invention. Computing platform 300 may also be implemented or provided with a wide variety of components or subsystems including, for example, one or more of the following: a central processing unit, a co-processor, memory, registers, and/or other data processing devices and subsystems.

Voice response unit 400 may be implemented using, for example, a voice response unit available from Aspect Telecommunications, Corp. of San Jose, California. One skilled in the art will appreciate that voice response units made by other manufacturers may be used consistent with the present invention. In addition, call routing and prioritization functionality may be incorporated into the communications network 600 through the use of call routing software designed to provide such functions. One example is the Geotel software program available from Cisco Systems Inc. of San Jose, Calif.

As indicated above, computing platform 300 communicates with customers 810, 820, . . . 860 through voice response unit 400, which in turn communicates with customers through communications network 600. Communications network 600 may comprise, alone or in any suitable combination, a telephony-based network (such as a PBX or POTS), a local area network (LAN), a wide area network (WAN), a dedicated intranet, and/or the Internet. Further, any suitable combination of wired and/or wireless components and systems may be incorporated into communications network 600.

Computing platform 300 also communicates with voice response unit 400 and database 500 through the use of direct connections or communication links, as illustrated in FIG. 1. Alternatively, communication between computing platform 300 and voice response unit 400, and communication between computing platform 300 and database 500 may be achieved through the use of a network architecture (not shown) similar to that described above for communications network 400. By using dedicated communication links or shared network architecture, computing platform 300 may be located in the same location or at a geographically distant location from voice response unit 400 and/or database 500.

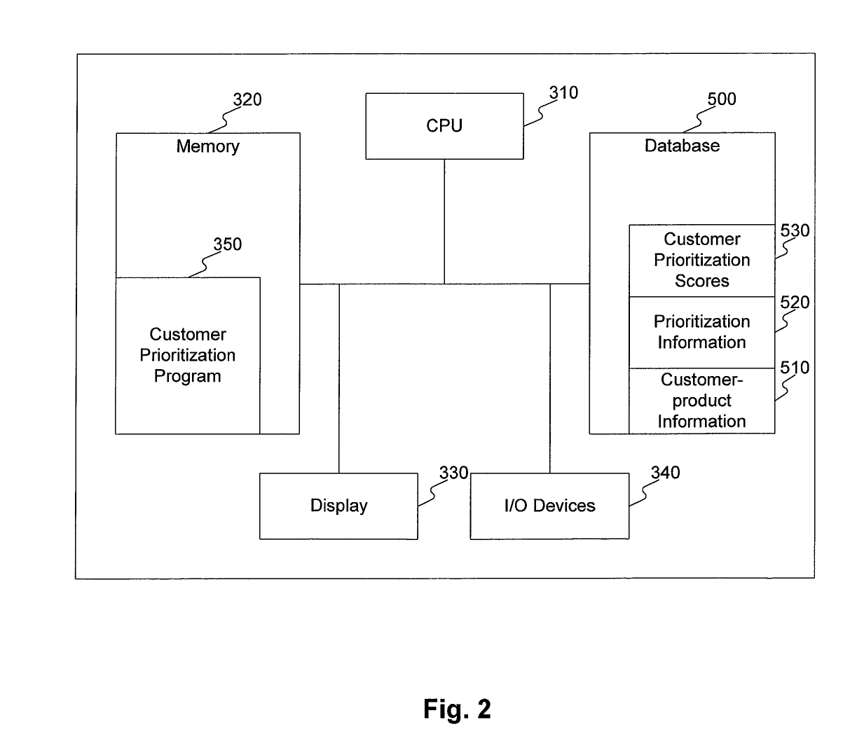

FIG. 2 depicts an exemplary system consistent with the present invention. As shown in FIG. 2, computing platform 300 may include a CPU 310, a memory 320, a display 330, and I/O devices 340. Memory 320 further includes customer prioritization program 350, which when executed by CPU 310 provides a part of the prioritization functionality associated with the present invention. FIG. 2 further depicts database 500, which is connected to the various components of the computing platform 300 and may be stored on a storage device, such as a hard disk. Database 500 includes customer-product information 510, prioritization information 520, and customer prioritization scores 530. Customer-product information 510 may include financial information concerning potential customers, such as credit related information. Customer-product information 510 may also include other information that helps the system in prioritizing the calls to generate the highest net present value, for example. Net present value may be based on two factors: customer likelihood to purchase, and expected value of purchase, when a purchase is made. Thus, for example, customer-product information 510 may include information on indicators of ability to purchase, such as credit scores and other financial attributes, such as annual income levels. Customer-product information 510 may also include product-defined attributes, such as a product requiring a credit card as the only means of payment. Customer-product information 510 may also include customer predisposition to purchase based on factors such as offer solicited, marketing channel utilized, and previous history of purchases and/or inquiries. Prioritization information 520 may include pre-computed prioritization scores for customers, who may have been solicited in the past. Customer prioritization scores 530 may include scores for customers that are computed based on their responses to queries from the voice response unit.

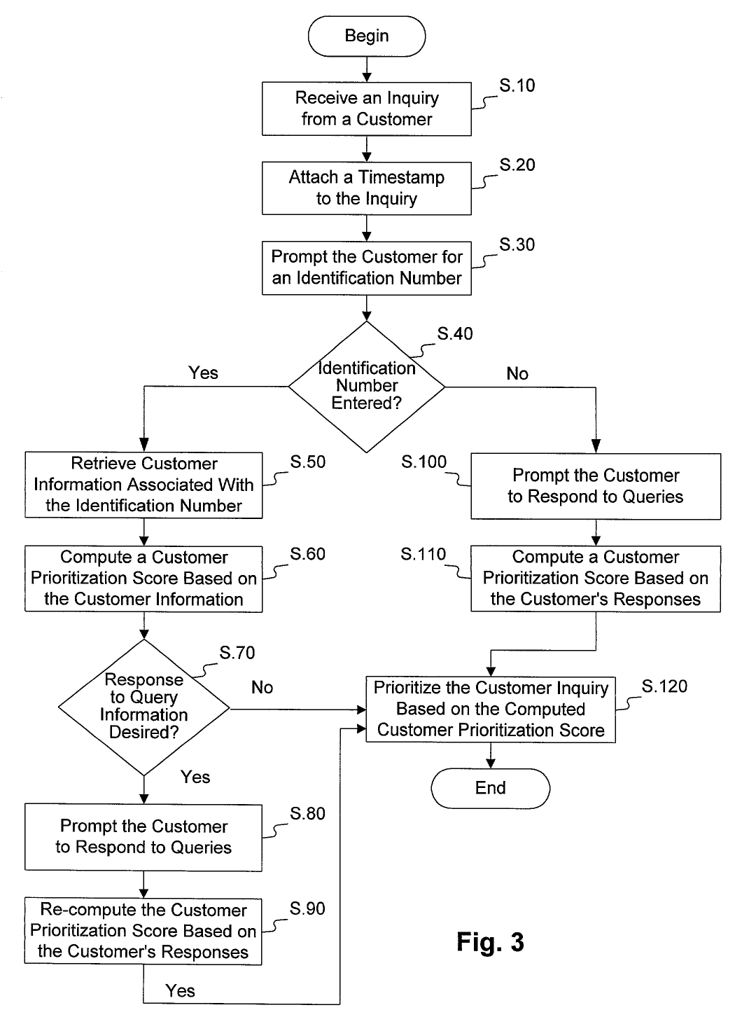

FIG. 3 depicts exemplary flowchart of a process for prioritizing a call consistent with the present invention. When a customer makes an inquiry, the inquiry is received by voice response unit 400 (S.10). One of ordinary skill in the art will appreciate that the inquiry from the customer may be received via a landline or a wireless connection. In addition, the customer inquiry may be a conventional telephone call or may be a call through the Internet, for example, using any of the voice over IP techniques.

Upon receipt of the inquiry, voice response unit 400 may attach a time-stamp to the customer inquiry to record the arrival time of the inquiry (S.20). Next, the customer may be prompted for an identification number (S.30). The identification number may be a solicitation number that may have been attached, for example, to a solicitation letter sent to the customer. One skilled in the art will appreciate that any identification code for identifying the customer may be used, such as a driver's license number, telephone number or a social security number. One skilled in the art will also appreciate that using technology, such as caller ID, the identification number may be obtained automatically and thereby obviate the need for requesting the identification number.

Next, computing platform 300, alone or in combination with voice response unit 400, determines whether an identification number was entered (S.40). If an identification number was entered by the customer, then computing platform 300 retrieves customer information associated with the identification number (S.50). Customer information associated with the customer may include prioritization information 520 and customer-product information 510 stored in database 500, as shown in FIG. 2. Prioritization information 520 may further include pre-determined customer prioritization scores for those customers to whom a solicitation letter was sent, for example. Customer prioritizations scores may be determined, as described in more detail below, by analyzing each customer's likelihood to purchase a product and the expected value of such a product.

One skilled in the art will recognize that there are numerous methods for calculating customer prioritization scores using the information stored in database 500, for example. The proper prioritization scheme to apply in any given application is determined by the overall business objective of the customer contact center. For example, computing platform 300 may prioritize customer inquiries based on which calls are likely to generate the highest net present value for the business. Net present value may be based on two factors: customer likelihood to purchase, and an expected value of a purchase. A customer's likelihood to make a purchase may, in turn, be determined from the customer's ability and predisposition to make a purchase. Indicators of ability to purchase include, but are not limited to, credit scores and other financial information, product-defined attributes such as a product requiring a credit card as the only means of payment and responses to queries. In addition, consumer predisposition to purchase may be indicated by the offer solicited, the marketing channel utilized, or by the previous history of purchases or inquiries. Finally, the expected value of a purchase may be determined based on the product offered and the expected needs of the consumer. Various forms of logical, numerical, or statistical techniques may then be used to model the likelihood to purchase and the expected value of the purchase based on the above criteria.

As part of this process, computing platform 300 may review a credit profile associated with the caller, stored in database 500, and determine whether the caller has good credit. One skilled in the art will appreciate that database 500 may store summarized credit profiles of customers in order to reduce processing time. Other prioritization information may relate to whether the customer has a checking account or not. One skilled in the art will appreciate that as part of this step, computing platform 300 may obtain additional information, as necessary, from other sources of information, such as financial clearing houses, via communications network 600.

Next, computing platform 300 computes a customer prioritization score based on the customer information, if a predetermined score for the customer is not found in prioritization information 520, stored in database 500 (S.60), then a new customer prioritization score is computed. Computing platform 300 may compute the customer prioritization score using several techniques. In one implementation, for example, a table stored in database 500 may include predetermined scores, each associated with various factors describing a customer's likelihood to purchase and an expected value of a purchase. For example, the table may define a prioritization score for a customer who owns a credit card and wishes to purchase a cellular service plan. One skilled in the art will appreciate that other known statistical and numerical modeling techniques may be used to accomplish this step including regression analyses, Boolean logic, statistical hypothesis testing logic, or decision trees. Upon receiving the customer information, computing platform 300 then searches for the table entries corresponding to each of the various factors describing the customer's likelihood to purchase and the expected value of the purchase, and then outputs the corresponding predetermined prioritization score. The computed scores are then associated with the particular customer and are placed in prioritization score database 530. One skilled in the art will appreciate that where predetermined customer prioritization scores are already stored in database 500 (e.g., in the above example) there may not be a need to compute the score again.

Computing platform 300 then determines whether to prompt the customer to respond to predetermined prioritization queries (S.70). Computing platform 300 may make this determination when there is insufficient information concerning the customer in database 500. Thus, for example, where database 500 has an insignificant amount of information on the customer, then computing platform 300 may require additional information. This step may be implemented by setting a lower limit on the number of factors corresponding to which database 500 must have information for computing platform 300 to determine a customer's likelihood to purchase. For example, if computing platform 300 determines the need for additional information, then voice response unit 400 prompts the customer to respond to predetermined prioritization queries that are formulated to obtain information concerning the customer's likelihood of purchasing a product or service, or concerning an expected value of a purchase (S.80). For example, the prioritization queries that are formulated to obtain information concerning a customer's financial situation (e.g., whether the customer has a credit card or a checking account) or whether the customer desires to purchase a particular product. Thus, as part of this step, the customer may be prompted for various types of information that may be used in prioritizing the call. While requesting more information from the customer may help to better prioritize the call, seeking more information may delay the call to the extent that the customer abandons it. Thus, the system consistent with the invention prompts the customer for only the optimum amount of information.

In one implementation consistent with the present invention, a cellular service plan is offered, which can only be purchased by a customer who either has a credit card, or has a checking account and wants to apply for a credit card. As part of this implementation, VRU 400 asks whether the customer owns a credit card. If the customer answers yes, then computing platform 300 assigns the customer a high prioritization score. If, however, the customer answers no, then VRU 400 asks whether the customer has a checking account. If the customer answers yes, then VRU 400 also asks whether the customer would like to apply for a credit card offered by the business. If the customer again answers yes, then platform 300 assigns the customer a middle-level score. The system may predefine a middle-level score for this response because the fact that the customer has a checking account indicates that the customer has at least some means to purchase the offered product. Also, once the customer applies for and is approved for a credit card, the customer may then subscribe to the offered cellular service plan. If, on the other hand, the customer does not apply for a credit card, then the customer is assigned a lower-level score. This is because the customer will not be able to purchase, for example, the cellular service plan. One skilled in the art will appreciate that in one implementation the call may be terminated at this point, for example, where the customer may not purchase the product at issue unless the customer has answered at least one of the questions affirmatively.

Next, computing platform re-computes the customer prioritization score based on the customer information (S.90). Computing platform 300 may compute the customer prioritization score using several techniques. In one implementation, for example, a table stored in database 500 may include pre-determined scores for each type of response to the prioritization queries. One skilled in the art will recognize, however, that there are numerous other methods for calculating customer prioritization scores.

If in step S.40, the customer does not enter an identification number, then voice response unit 400 prompts the customer to respond to the prioritization queries as described above with regards to steps S.70 and S.80. One skilled in the art will appreciate that the customer inquiries are preferably the same, but they may be different.

After receiving the customer's responses to the prioritization queries, computing platform 300 computes a customer prioritization score based on the received responses (S. 110). Computing platform 300 preferably computes the score in the manner described above with regards to S.90. However, one skilled in the art will recognize that there are numerous methods for calculating customer prioritization scores, as discussed earlier.

Next, based on the computed customer prioritization score stored in database 530, platform 300 prioritizes the customer inquiry (S.120). As part of this step, the customer inquiry with the highest score may be served first and then the one with the next highest score and so on. Alternatively, the customer inquiry may be assigned to one of a multiple queues based on the computed score, where the queues may have different levels of service. For example, the call may be assigned to a high priority queue, a middle priority queue, or a low priority queue. Higher priority queue preferably has a lower wait time associated with it than the lower priority queue. One skilled in the art will appreciate, however, that more than three queues with different levels of priority may be created to which the customer inquiries could be assigned. In addition, one skilled in the art will recognize the ability to route calls to specific agents or groups of agents with the skill level commensurate with maximizing the value of the customer contact opportunity.

The timestamp associated with each call may be used to order customer inquiries within each queue. Thus, for example, customer inquiries within a queue are processed in the order they were received according to the time stamp.

Other modifications and embodiments of the invention will be apparent to those skilled in the art from consideration of the specification and practice of the invention disclosed herein. For example, one skilled in the art will appreciate that the systems and methods consistent with the present invention may be used not only to prioritize telephone call, but also may be used to prioritize solicitation received via other means, for example, instant messages over the Internet. Therefore, it is intended that the specification and examples be considered as exemplary only, with a true scope and spirit of the invention being indicated by the following claims.

What is claimed is:

1. A method for prioritizing a customer inquiry, the method comprising:
receiving an inquiry from a customer;
prompting the customer to provide an identification number;
retrieving, when the customer provides the identification number, customer information about the customer based on the provided identification number;
computing a customer prioritization score based on the retrieved customer information; and
prioritizing the customer inquiry based on the computed customer prioritization score, such that higher prioritized customer inquiries are responded to sooner than lower prioritized customer inquiries.

2. The method of claim 1, wherein receiving the customer inquiry, further includes attaching to the inquiry a timestamp identifying the time the inquiry was received.

3. The method of claim 1, wherein the customer information comprises financial information describing the customer's likelihood to purchase an offered product.

4. The method of claim 1, wherein the customer information includes a predetermined customer prioritization score associated with likelihood that the customer may purchase an offered product.

5. The method of claim 1, wherein the customer inquiry with the highest score is responded to first.

6. The method of claim 1, wherein prioritizing the customer inquiry further includes assigning the customer inquiry to a particular queue based on the computed prioritization score.

7. The method of claim 2, wherein customer inquiries having the same prioritization score are responded to in the order they were received according to the time stamp.

8. The method of claim 1, wherein if additional customer information is needed, then the customer is prompted to respond to predefined prioritization queries created to determine the customer's likelihood to purchase an offered product.

9. The method of claim 8, wherein the customer prioritization score is re-computed based on the customer's responses to the predefined prioritization queries.

10. The method of claim 1, wherein prioritizing the customer inquiry further includes assigning the customer inquiry to at least one of a high-level queue, a mid-level queue, or a low-level queue, based on the computer prioritization score.

11. The method of claim 1, wherein each customer inquiry may be assigned to any one of a multiple queues, wherein each queue is associated with a range of predetermined scores, wherein the customer inquiries are assigned to one of the multiple queues based on the computed prioritization score and the associated ranges of the multiple queues, and wherein the customer inquiries assigned to queues with a higher range of predetermined scores are responded to sooner than customer inquiries assigned to queues with a lower range of predetermined scores.

12. A method for prioritizing a customer inquiry, the method comprising:
receiving an inquiry from a customer;
prompting the customer to provide customer information in response to a predetermined set of prioritization queries created to determine the customer's likelihood to purchase an offered product.;
when the customer provides customer information in response to the predetermined set of queries, computing a customer prioritization score based on the customer responses; and
prioritizing the customer inquiry based on the computed customer prioritization score, such that higher prioritized customer inquiries are responded to sooner than lower prioritized customer inquiries.

13. The method of claim 12, wherein each prioritization query is created to obtain a response providing information concerning a customer's likelihood to purchase and offered product or service.

14. The method of claim 12, wherein receiving the customer inquiry, further includes attaching to the inquiry a timestamp identifying the time the inquiry was received.

15. The method of claim 12, wherein each possible response to one of the predetermined prioritization queries is associated with a predetermined score.

16. The method of claim 12, wherein the customer information comprises information concerning whether the customer has financial means for purchasing an offered product.

17. The method of claim 12, wherein the customer information comprises information concerning whether the customer desires to purchase an offered product.

18. The method of claim 12, wherein the customer information comprises whether the customer has a credit card.

19. The method of claim 12, wherein the customer information comprises whether the customer has a checking account.

20. The method of claim 12, wherein prioritizing the customer inquiry further includes assigning the customer inquiry to at least one of a high-level queue, a mid-level queue, or a low-level queue, based on the computer prioritization score.

21. The method of claim 12, wherein each customer inquiry may be assigned to any one of a multiple queues, wherein each queue is associated with a range of predetermined scores, wherein the customer inquiries are assigned to one of the multiple queues based on the computed prioritization score and the associated ranges of the multiple queues, and wherein the customer inquiries assigned to queues with a higher range of predetermined scores are responded to sooner than customer inquiries assigned to queues with a lower range of predetermined scores.

22. A system for prioritizing a customer inquiry, the system comprising:
means for receiving an inquiry from a customer;
means for prompting the customer provide an identification number;
means for retrieving, when the customer provides the identification number, customer information about the customer based on the provided identification number;
means for computing a customer prioritization score based on the retrieved customer information; and
means for prioritizing the customer inquiry based on the computed customer prioritization score, such that higher prioritized customer inquiries are responded to sooner than lower prioritized customer inquiries.

23. The system of claim 22, wherein means for receiving the customer inquiry, further includes means for attaching to the inquiry a timestamp identifying the time the inquiry was received.

24. The system of claim 22, wherein the customer information comprises financial in formation describing the customer's likelihood to purchase an offered product.

25. The system of claim 22, wherein the customer information includes a predetermined customer prioritization score associated with likelihood that the customer may purchase an offered product.

26. The system of claim 22, wherein the customer inquiry with the highest score is responded to first.

27. The system of claim 22, wherein means for prioritizing the customer inquiry further includes means for assigning the customer inquiry to a particular queue based on the computed prioritization score.

28. The system of claim 23, wherein customer inquiries having the same prioritization I score are responded to in the order they were received according to the time stamp.

29. The system of claim 22, wherein if additional customer information is needed, then the customer is prompted to respond to predefined prioritization queries created to determine the customer's likelihood to purchase an offered product.

30. The system of claim 29, wherein the customer prioritization score is re-computed based on the customer's responses to the predefined prioritization queries.

31. The system of claim 22, wherein means for prioritizing the customer inquiry further includes means for assigning the customer inquiry to at least one of a high-level queue, a mid-level queue, or a low-level queue, based on the computer prioritization score.

32. The system of claim 22, wherein each customer inquiry may be assigned to any one of a multiple queues, wherein each queue is associated with a range of predetermined scores, wherein the customer inquiries are assigned to one of the multiple queues based on the computed prioritization score and the associated ranges of the multiple queues, and wherein the customer inquiries assigned to queues with a higher range of predetermined scores are responded to sooner than customer inquiries assigned to queues with a lower range of predetermined scores.

33. A system for prioritizing a customer inquiry, the system comprising:
means for receiving an inquiry from a customer;
means for prompting the customer to provide customer information in response to a predetermined set of prioritization queries created to determine the customer's likelihood to purchase an offered product.;
when the customer provides customer information in response to the predetermined set of queries, means for computing a customer prioritization score based on the customer responses; and
means for prioritizing the customer inquiry based on the computed customer prioritization score, such that higher prioritized custom er inquiries are responded to sooner than lower prioritized customer inquiries.

34. The system of claim 33, wherein each prioritization query is created to obtain a response providing information concerning a customer's likelihood to purchase and offered product or service.

35. The system of claim 33, wherein means for receiving the customer inquiry, further includes means for attaching to the inquiry a timestamp identifying the time the inquiry was received.

36. The system of claim 33, wherein each possible response to one of the predetermined prioritization queries is associated with a predetermined score.

37. The system of claim 33, wherein the customer information comprises information concerning whether the customer has financial means for purchasing an offered product.

38. The system of claim 33, wherein the customer information comprises information concerning whether the customer desires to purchase an offered product.

39. The system of claim 33, wherein the customer information comprises whether the customer has a credit card.

40. The system of claim 33, wherein the customer information comprises whether the customer has a checking account.

41. The system of claim 33, wherein means for prioritizing the customer inquiry further includes means for assigning the customer inquiry to at least one of a high-level queue, a mid-level queue, or a low-level queue, based on the computer prioritization score.

42. The system of claim 33, wherein each customer inquiry may be assigned to any one of a multiple queues, wherein each queue is associated with a range of predetermined scores, wherein the customer inquiries are assigned to one of the multiple queues based on the computed prioritization score and the associated ranges of the multiple queues, and wherein the customer inquiries assigned to queues with a higher range of predetermined scores are responded to sooner than customer inquiries assigned to queues with a lower range of predetermined scores.
